(19) United States
(12) Patent Application Publication
(10) Pub. No.: US 2007/0095792 A1
(43) Pub. Date: May 3, 2007

(54) Manually guided implement

(75) Inventors: Dieter Kremsler, Spiegelberg (DE); Klaus Langhans, Winnenden (DE)

Correspondence Address: ROBERT W. BECKER & ASSOCIATES, Suite B, 707 Highway 66 East, Tijeras, NM, 87059, US

(73) Assignee: Andreas Stihl AG & Co. KG, Waiblingen (DE)

(21) Appl. No.: 11/588,730

(22) Filed: Oct. 27, 2006

(30) Foreign Application Priority Data
Oct. 29, 2005 (DE) 10 2005 051 886.9

(51) Int. Cl. H01H 33/12

(52) U.S. Cl. 218/14

(57) ABSTRACT

A manually guided implement having a tool, and comprising a drive motor for driving the tool and disposed on a first end of a guide rod. The tool is disposed in a region of a second, opposite end of the guide rod. A housing is disposed on the guide rod at the second end, and an electrical insulator is disposed between the housing and the second end.

The instant application should be granted the priority date of Oct. 29, 2005 the filing date of the corresponding German patent application 10 2005 051 886.9.

### BACKGROUND OF THE INVENTION

The present invention relates to a manually guided implement such as a brushcutter, a trimmer, a pole pruner, or the like.

U.S. Pat. No. 5,896,669 discloses an overhead branch cutter according to which the guide rod connects the housing of the implement, in which the drive motor is disposed, with the gear mechanism housing of the implement. The tool is disposed on the gear mechanism housing, which is secured to the guide rod by means of a clamping connection. The gear mechanism housing is connected with the guide rod in an electrically conductive manner.

When working with an implement having a driven tool, electrical lines from the tool can become damaged or severed. Electrical devices have safety devices that, if damage or severance of an electrical line occurs, interrupts the supply of current, so that injury to the operator is prevented. However, in rare cases even such safety devices can become damaged or can fail.

It is therefore an object of the present invention to provide a manually guided implement of the aforementioned general type that further increases the safety of the operator.

### BRIEF DESCRIPTION OF THE DRAWINGS

This object, and other objects and advantages of the present invention, will appear more clearly from the following specification in conjunction with the accompanying schematic drawings, in which:

FIG. 1 is a perspective illustration of a manually guided implement;

FIG. 2 is a perspective illustration of the gear mechanism housing of the implement of FIG. 1;

FIG. 3 is a perspective view of a half shell of the insulating sleeve;

FIG. 4 is a side view of the insulating sleeve;

FIG. 5 is a side view of the insulating sleeve taken in the direction of the arrow V in FIG. 4;

FIG. 6 is a cross-sectional view taken along the line VI-VI in FIG. 5;

FIG. 7 is a cross-sectional view taken along the line VII-VII in FIG. 6;

FIG. 8 is an end view taken in the direction of the arrow VIII in FIG. 4;

FIG. 9 is an end view taken in the direction of the arrow IX in FIG. 4; and

FIGS. 10 & 11 are perspective illustrations of manually-guided implements.

### SUMMARY OF THE INVENTION

The manually-guided implement having a tool pursuant to the present application comprises a guide rod, a drive motor for driving the tool, wherein the drive motor is disposed on a first end of the guide rod and the tool is disposed in the region of a second opposite end of the guide rod, a housing disposed on the guide rod at the second end, and, for avoiding an electrical charging of the guide rod, an electrical insulator disposed between the housing and the second end.

Due to the presence of the electrical insulator between the housing at the second end of the guide rod, and the guide rod, a transfer of charges from the housing to the guide rod is avoided. As a result, even if the safety device fails due to being severed or because the electrical line is damaged, a transfer of electrical charges to the guide rod can be avoided. Even if the operator of the implement grasps the guide rod instead of the handle, or accidentally contacts the guide rod, a transfer of electrical charges to the operator is avoided since the guide rod itself is electrically insulated from the gear mechanism housing in the tool. This provides as great a safety for the operator as possible.

The housing at second end of the guide rod is preferably a gear mechanism housing in which is disposed a gear mechanism for transferring the drive movement generated by the drive motor to the tool. With such implements it is customary to transfer the drive movement through the guide rod via a drive shaft that is mounted in the guide rod. To convert the drive movement into the drive movement needed by the tool, for example a rotational movement in a direction transverse to the longitudinal direction of the drive shaft, the gear mechanism disposed in the gear mechanism housing is provided. As a result, the drive movement can easily be transferred through the guide rod. The housing is expediently held on the second end of the guide rod by means of a clamping connection. This results in a straightforward configuration. An adequate support of the housing and of the tool on the guide rod can be ensured, so that the housing is fixed on the guide rod and cannot move relative to the guide rod.

So that the clamping force can be reliably transferred via the insulator from the housing to the guide rod, and so that the electrical insulator has an adequate strength, the electrical insulator can be made of a polymeric material, especially glass fiber reinforced polymeric material. The glass fiber content is in particular approximately 30%. Due to the glass fiber content, a creeping of the electrical insulator under load can also be avoided, thereby ensuring the long-time stability of the clamping connection on the electrical insulator.

A straightforward configuration can be achieved if the electrical insulator is formed by an insulating sleeve. In this connection, the insulating sleeve has a cylindrical inner surface and a cylindrical outer surface, as a result of which a good strength of the tolerance-sensitive clamping connection between the housing and the guide rod can be ensured. The insulating sleeve is preferably disposed in a receiver in the housing, whereby the second end of the guide rod extends into the insulating sleeve.

The insulating sleeve is preferably formed of two half shells. As a result, the cylindrical shape can be ensured, especially when the insulating sleeve is produced from polymeric material. At the same time, it is easy to remove the two half shelves from the molds, so that manufacturing is simplified and there is no need for additional cores. The two half shells are preferably embodied as identical components, so that only a single mold is required to produce the insulating sleeve, and the inventory is reduced. By constructing the insulating sleeve from two identical half shells, a good accuracy to size of the cylindrical insulating sleeve can be achieved, and low tolerances can be maintained. To fix the position of the two half shells of the insulating sleeves relative to one another, the half shells can overlap in the circumferential direction. One half shell, on at least one longitudinal side that extends parallel to the longitudinal central axis of the insulating sleeve, is preferably provided with a recess that extends parallel to the longitudinal central axis, and the other half shell, on the associated longitudinal side is provided with an edge that extends parallel to the longitudinal central axis, whereby the edge of the one half shell projects into the recess of the other half shell. Where the half shells have an identical construction, each half shell has one edge and one recess, whereby an edge of one half shell respectively projects into the recess of the other half shell.

The insulating sleeve expediently has means to fix the position of the insulating sleeve relative to the housing. As a result, the position in the housing can be fixed in a straightforward manner without requiring additional components. Even during installation a correct positioning of the components relative to one another is thereby ensured. The insulating sleeve can be provided with a collar that limits the depth of insertion of the insulating sleeve into the housing. In this connection, the collar is in particular disposed on the front side of the housing. The insulating sleeve is expediently held in the housing in the direction of its longitudinal central axis by means of an arresting connection. The arresting connection in particular prevents movement of the insulating sleeve out of the housing, so that the position of the insulating sleeve, in the direction of its longitudinal central, is fixed by the collar and the arresting connection. To fix the rotational position of the insulating sleeve in the housing, the insulating sleeve is advantageously provided with a longitudinal rib that cooperates with the housing. To fix the position of the insulating sleeve on the guide rod, the insulating sleeve can have a shoulder that forms an abutment for the guide rod. As a result, the relative position of the gear mechanism housing to the guide rod is also fixed by means of the insulating sleeve. The present application is in particular provided for implements where the drive motor is an electric motor, where a severance of the connection cable of the implement can occur.

Further specific features of the present application will be described in detail subsequently.

### DESCRIPTION OF SPECIFIC EMBODIMENTS

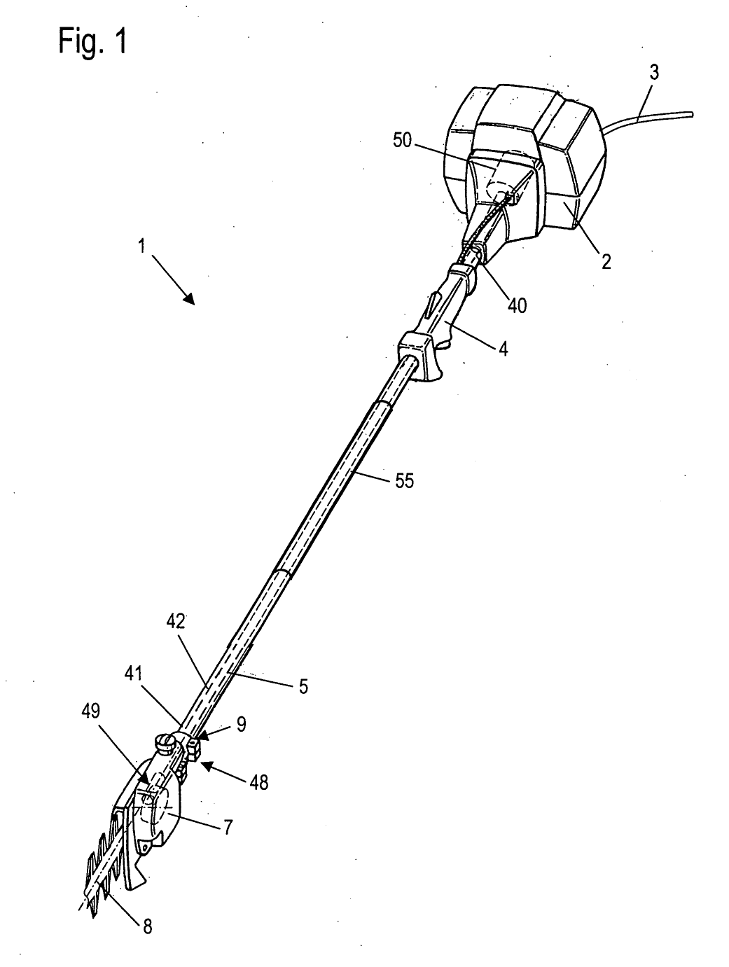

Referring now to the drawings in detail, in FIG. 1 a trimmer 1 is shown as an example for a manually-guided implement. However, the manually-guided implement can also be a brushcutter, a pole pruner or the like. The trimmer 1 includes a motor housing 2 in which is disposed the drive motor 50, which is schematically indicated in FIG. 1 and is embodied as an electric motor. To supply energy to the drive motor 50, the motor housing 2 has an electrical connecting cable 3. The trimmer 1 also includes a guide rod 5; the motor housing 2 is secured to a first, motor-side end 40 of the guide rod 5. Disposed adjacent to the motor housing 2, on the guide rod 5, is a handle 4 for guiding the trimmer 1. The handle 4 surrounds the guide rod 5. A portion of the length of the guide rod 5 is surrounded by a grip hose 55 at which the operator can grip the trimmer with his or her other hand. However, a handle could also be secured to the guide rod 5 for guiding the trimmer 1. A handle frame from which one or two handles are disposed can also be expedient. At the opposite, tool-side end 41 of the guide rod 5 a gear mechanism housing 7 is secured by means of a clamping connection 48, which is schematically indicated in FIG. 1. In this connection, the guide rod 5 extends into a receiver 9 of the gear mechanism housing 7. A drive shaft 42, which transfers the drive motion of the drive motor 50 to the gear mechanism housing 7, extends through the hollow guide rod 5. Disposed in the gear mechanism housing 7 is a gear mechanism 49 which is schematically indicated in FIG. 1. Extending out of the gear mechanism housing 7 is the shearing blade 8 of the trimmer 1, which is driven by the gear mechanism 49 and is mounted in the gear mechanism housing 7.

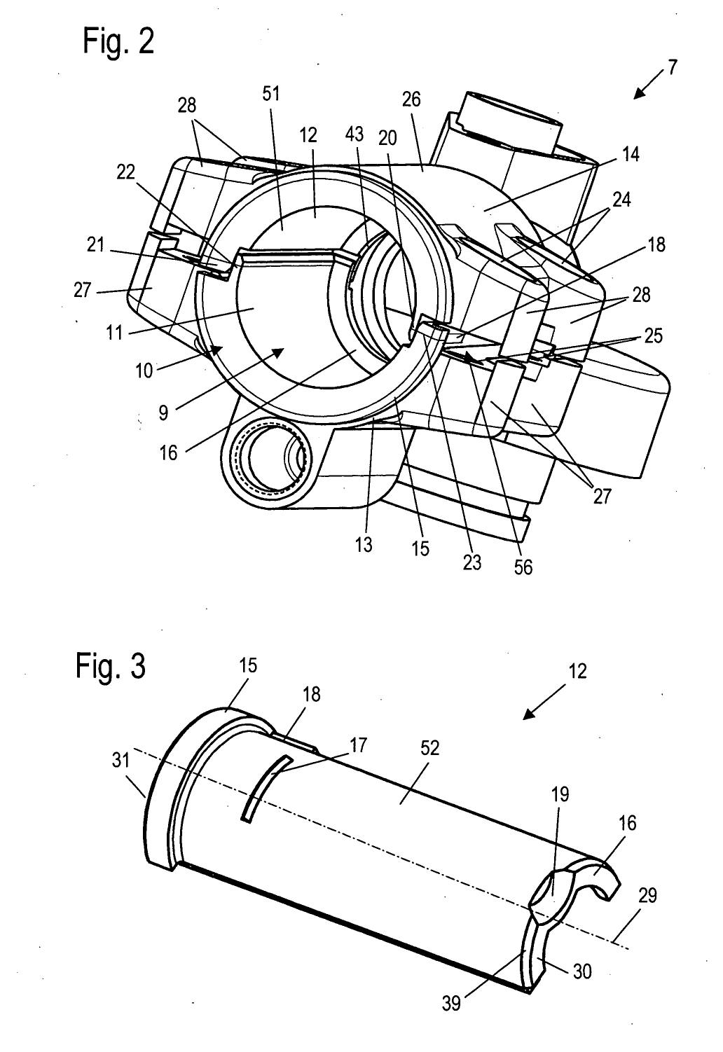

The gear mechanism housing 7 is illustrated in an enlarged view in FIG. 2. The gear mechanism housing 7 has a sleeve-like portion 26 in which is formed the receiver 9 for the guide rod 5. The sleeve-like portion 26 has a longitudinal slot 56 that divides the sleeve-like portion 26 into two half shells 13 and 14, which are connected via the clamping connection 48 (FIG. 1) with the guide rod 5, which is not shown in FIG. 2. However, the gear mechanism housing 7 can also be formed in two parts. Disposed in the sleeve-like portion 26 is an insulating sleeve 10. The inner surface 51 of the insulating sleeve 10 rests against the guide rod 5 in the installed state, while the outer surface 52 of the insulating sleeve 10 shown in FIG. 3 rests against the gear mechanism housing 7.

The insulating sleeve 10 is formed of two half shells 11, 12 that rest against one another approximately in the plane of separation between the half shells 13 and 14 of the gear mechanism housing 7. As a result, the first half shell 11 is disposed essentially in the first half shell 13 of the gear mechanism housing 7 and the second half shell 12 is disposed essentially in the second half shell 14 of the gear mechanism housing 7. The two half shells 11 and 12 of the insulating sleeve 10 are identical, in other words, are embodied as identical components. The identical half shells 11, 12 have an outwardly projecting collar 15 that rests against the gear mechanism housing 7 on that side that faces the motor housing 2 of the trimmer 1; the depth of insertion of the insulting sleeve 10 into the gear mechanism housing 7 is limited. At the opposite end the two half shells 11 and 12 of the insulating sleeve 10 have an inwardly projecting shoulder 16 that limits the depth of insertion of the guide rod 5 into the insulating sleeve 10.

The two half shells 11, 12 of the insulating sleeve 10 overlap one another in the peripheral direction in the region of the plane of separation. For this purpose, the first half shell 11 has an inner longitudinal edge 22 that extends in the longitudinal direction of the insulating sleeve 10. Adjacent to the inner longitudinal edge 22, the second half shell 12 has an outer longitudinal edge 21 that rests against the inner longitudinal edge 22 radially outwardly of the inner longitudinal edge. On the opposite side, the second half shell 12 has an inner longitudinal edge 20 that rests against an outer longitudinal edge 23 of the first half shell 11. As a result, the two half shells 11 and 12 are secured relative to one another in a radial direction. Since the two half shells 11, 12 have an identical configuration, the two inner longitudinal edges 20 and 22, and the two outer longitudinal edges 21 and 23, respectively correspond to one another.

For the clamping connection 48, via which the gear mechanism housing 7 is fixed in position on the guide rod 5, the first half shell 13 of the sleeve-like portion 26 has four jaws 27 that are fixed on the sleeve-like portion 26 and extend outwardly. In this connection, two jaws are disposed on each side of the insulating sleeve 10. Relative to the plane of the longitudinal slot 56, four jaws 28 are fixed in position in the second half shell 14 symmetrical to and opposite from the jaws 27. The jaws 27 are provided with securement bores 25, and the jaws 28 are provided with securement bores 24. Tightening screws, which are not shown in FIG. 2, extend through the securement bores to clamp the two half shells 13 and 14 together. As a result, the two half shells 11 and 12 of the insulating sleeve 10 are also pressed against one another and against the guide rod 5. This results in a fixed connection of the gear mechanism housing 7 on the guide rod 5.

The insulating sleeve 10 is expediently made of a polymeric material, especially PA 66 which is reinforced with glass fibers. The glass fiber content is expediently approximately 30%. In this way, a high mechanical strength for the insulating sleeve 10 is achieved, thus preventing creeping of the material during operation. This ensures that the gear mechanism housing 7 is fixedly disposed on the guide rod 5.

FIGS. 3 to 9 show the construction of the second half shell 12 in detail. The first half shell 11 is identical in construction to the second half shell 12. As shown in FIG. 3, adjacent to the collar 15 the first half shell 12 has a longitudinal rib 18, which extends parallel to the longitudinal central axis 29 of the insulating sleeve 10. The longitudinal ribs 18 of the identical half shells 11, 12 are disposed in the longitudinal slot 56 and thus fix the rotational position of the insulating sleeve 10 in the gear mechanism housing 7 (FIG. 2). At that end opposite the collar 15, which during operation is disposed within the gear mechanism housing 7, the half shell 12 is provided with the radially inwardly extending annular shoulder 16. This annular shoulder 16 merges via a bevel 39 into the outer surface 52. Adjacent to the annular shoulder 16, the half shell 12 is provided with a recessed area 19 that is disposed approximately in the middle of the periphery of the half shell 12 and extends radially inwardly from the outer surface 52. As a result, sufficient installation space is available for components of the gear mechanism housing 7, especially screws. For the fixation of the half shell 12 in the direction of the longitudinal central axis 29, the half shell 12 is provided with a transverse fin 17, which is embodied as an arresting element.

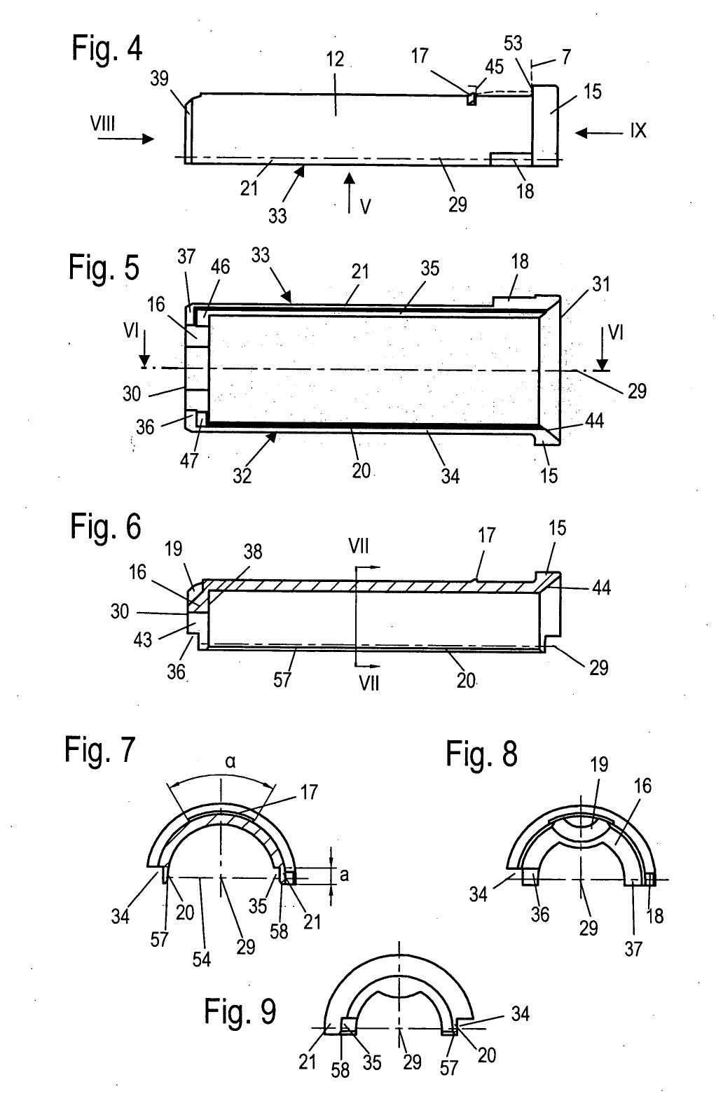

As schematically shown in FIG. 4, during operation the fin or stop 17 is disposed behind an arresting edge of the gear mechanism housing 7. The collar 15 rests against a surface 53 of the gear mechanism housing 7. By means of the collar 15 and the transverse fin 17 the half shell 12 is thus secured in the gear mechanism housing 7 in the direction of the longitudinal central axis 29.

As shown in FIGS. 4 to 9, the half shell 12 is provided on its longitudinal side 33, which is disposed toward the front in FIG. 4, with the outer longitudinal edge 21. Radially inwardly of the outer longitudinal edge 21, the second half shell 12 is provided with a longitudinal recess 35, which extends parallel to the longitudinal central axis 29. As shown in FIG. 2, the longitudinal recess 35 serves for receiving the inner longitudinal edge 22 of the first half shell 11. The outer longitudinal edge 21 has an edge section 37 that extends on the annular shoulder 16 at the rear end face 30 of the half shell 12. The rear end face is that end face that faces away from the collar 15. Also the longitudinal recess 35 continues with a transverse recess 46 at the annular shoulder 16. Due to the construction of the half shells 11 and 12 as identical components, the outer longitudinal edge 23 has an identical configuration to the outer longitudinal edge 21.

The opposite longitudinal side 32 of the second half shell 12 has the inner longitudinal edge 20, which extends parallel to the longitudinal central axis 29 over nearly the entire length of the half shell 12; the longitudinal edge 20 continues in an edge section 47 at the annular shoulder 16. Formed radially beyond the inner longitudinal edge 20 is a longitudinal recess 34 that, as shown in FIG. 2, serves for receiving the outer longitudinal edge 23 of the half shell 11. The longitudinal recess 34 continues at the annular shoulder 16 in a transverse recess 36. At the front end face 31, which is disposed adjacent to the collar 15, the half shell 12 has a bevel 44, which facilitates insertion of the guide rod 5 into the insulating sleeve 10 during assembly. The inner longitudinal edge 22 of the first half shell 12 is identical in construction to the inner longitudinal edge 20 of the second half shell 12.

As shown in the cross-sectional view of FIG. 6, in the interior of the half shell 12 the annular shoulder 16 forms an abutment 38 for the guide rod 5, which is not shown in FIG. 6. At the end face 30, the half shell 12 has an opening 43, which is delimited by the annular shoulder 16. By means of the opening 43, the drive shaft 42 of the trimmer 1 can extend through the insulating sleeve 10 to the gear mechanism 49 that is disposed in the gear mechanism housing 7.

As shown in FIG. 7, the transverse fin 17 extends over an angle α, which is preferably approximately 60°. The longitudinal recesses 34 and 35, and the longitudinal edges 20 and 21, each extend over the plane 54 of the longitudinal slot 56 of the gear mechanism housing 7. The longitudinal recesses 34 and 35, and the longitudinal edges 20 and 21, have a height a that is preferably 10 to 20% of the inner diameter of the insulating sleeve 10. At those edges that face the longitudinal central axis 29, the longitudinal edges 20 and 21 are provided with a bevel 57, 58.

Since the two half shells 11 and 12 of the insulating sleeve 10 are designed as identical components, the description of the second half shell 12 also pertains to the identical first half shell 11. Due to the fact that a respective longitudinal edge of one half shell cooperates with a recess of the other half shell, a construction having identical components is possible.

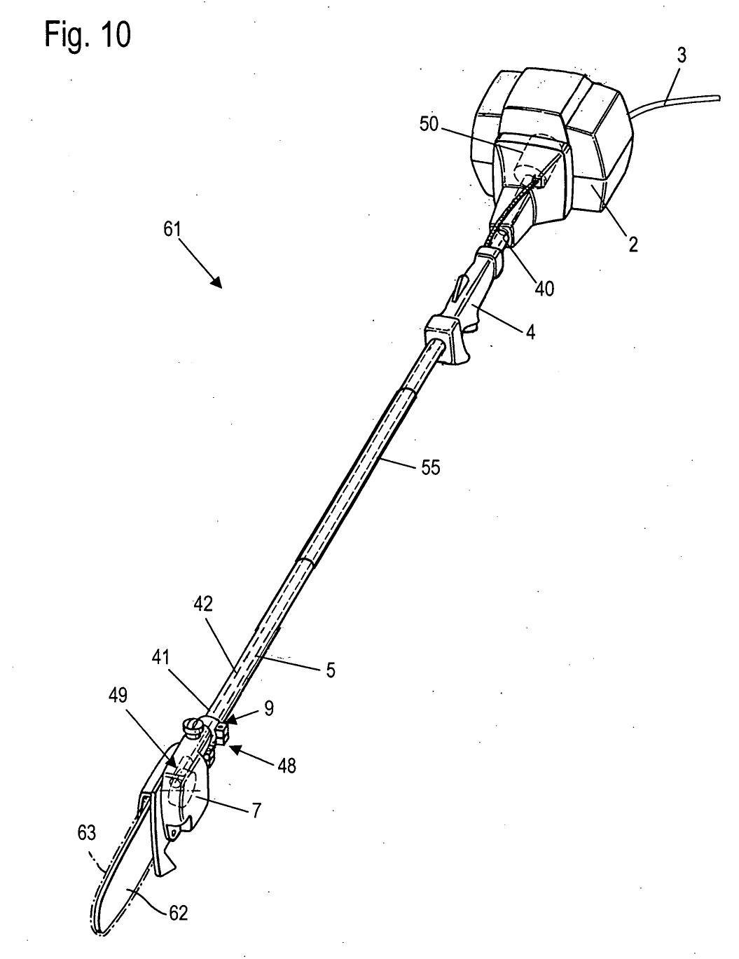

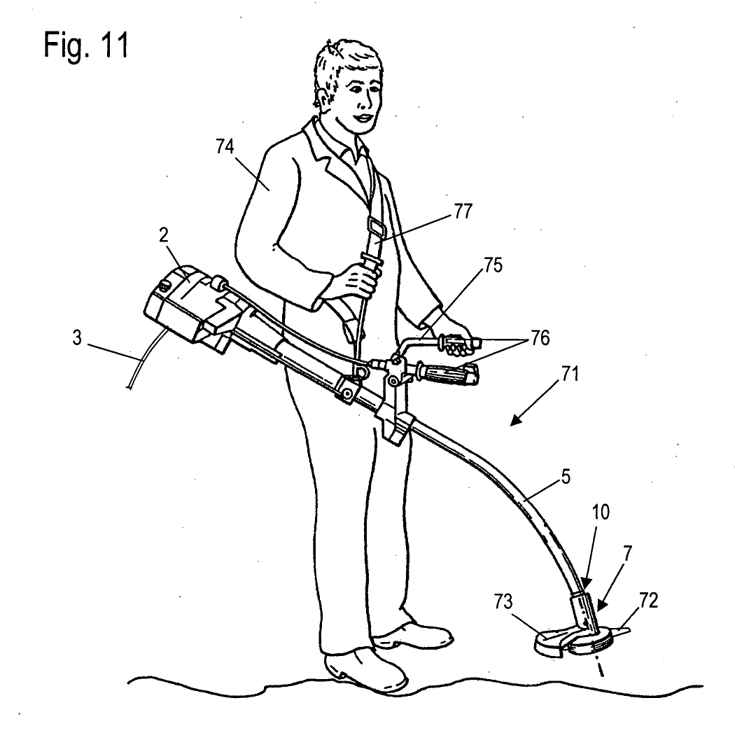

FIG. 10 shows a pole pruner 61. The construction of the pole pruner 61 corresponds essentially to the construction of the trimmer 1 shown in FIG. 1. However, the tool of the pole pruner 61 is a saw chain 63 that is schematically illustrated in FIG. 10 and circulates about a guide bar 62. The guide bar 62 is fixed in position on a gear mechanism housing 7 of the pole pruner 61 and is driven by a gear mechanism 49 that is disposed in the gear mechanism housing 7. The gear mechanism housing 7 has a receiver 9 in which the guide rod 5 is disposed in an insulating sleeve 10, which is not shown in FIG. 10. As a result, the saw chain 63 is electrically separated from the guide rod 5. As a result, injury to the operator is avoided if an electrical line is severed by the saw chain 63, even if the safety device fails and the operator accidentally contacts the guide rod 5.

FIG. 11 schematically illustrates a brush cutter 71, which is guided by an operator 74. The brushcutter 71 has a motor housing 2 that is fixed at one end of a guide rod 5. Disposed at the other end of the guide rod 5 is a gear mechanism housing 7, which is fixed on the guide rod 5 by means of an insulating sleeve 10 that electrically insulates the guide rod 5 from the gear mechanism housing 7. A blade 72 is rotatably driven on the gear mechanism housing 7. Fixed on the gear mechanism 7 is a guard 73, which screens the blade 72 on that side facing the operator 74. Fixed on the guide rod 5 is a handle frame 75 on which are disposed two handles 76 for guiding the brushcutter 71. Furthermore fixed on the guide rod 5 is a carrying strap 77 that the operator carries over the shoulder to absorb the weight of the brush. The structural configuration of the insulating sleeve 10 of the brushcutter 71 corresponds to the construction of the insulating sleeve shown in FIGS. 2 to 9. The arrangement of the drive motor, the drive shaft and the gear mechanism, which are not shown in FIG. 11, correspond to the arrangement of the trimmer shown in FIG. 1.

The specification incorporates by reference the disclosure of German priority document 10 2005 051 886.9 filed Oct. 29, 2005.

The present invention is, of course, in no way restricted to the specific disclosure of the specification and drawings, but also encompasses any modifications within the scope of the appended claims.

What I claim is:

1. A manually guided implement having a tool, comprising:
a guide rod;
a drive motor for driving the tool, wherein said drive motor is disposed on a first end of said guide rod, and wherein the tool is disposed in the region of a second, opposite end of said guide rod;
a housing disposed on said guide rod at said second end; and
an electrical insulator disposed between said housing and said second end of said guide rod.

2. An implement according to claim 1, wherein said housing is a gear mechanism housing, and wherein a gear mechanism is disposed in said gear mechanism housing to transfer a drive movement generated by said drive motor to the tool.

3. An implement according to claim 1, wherein a clamping connection is provided to support said housing at said second end of said guide rod.

4. An implement according to claim 1, wherein said electrical insulator is made of polymeric material.

5. An implement according to claim 4, wherein said polymeric material is glass fiber reinforced polymeric material.

6. An implement according to claim 5, wherein the glass fiber content is approximately 30%.

7. An implement according to claim 1, wherein said electrical insulator is formed by an insulating sleeve, and wherein said insulating sleeve has a cylindrical inner surface and a cylindrical outer surface.

8. An implement according to claim 7, wherein said insulating sleeve is disposed in a receiver provided in said housing, and wherein said second end of said guide rod projects into said insulating sleeve.

9. An implement according to claim 7, wherein said insulating sleeve is formed of two half shells.

10. An implement according to claim 9, wherein said two half shells are embodied as identical components.

11. An implement according to claim 9, wherein said half shells of said insulating sleeve overlap in a circumferential direction.

12. An implement according to claim 11, wherein one of said half shells, on at least one longitudinal side that extends parallel to a longitudinal central axis of said insulating sleeve, is provided with a recess that extends parallel to said longitudinal central axis, wherein the other of said half shells on at least one longitudinal side is provided with an edge that extends parallel to said longitudinal central axis, and wherein said edge of said other half shell projects into said recess of said one half shell.

13. An implement according to claim 7, wherein said insulating sleeve is provided with means for fixing the position of said insulating sleeve relative to said housing.

14. An implement according to claim 13, wherein said insulating sleeve is provided with a collar for limiting a depth of insertion of said insulating sleeve into said housing.

15. An implement according to claim 13, wherein an arresting connection is provided for holding said insulating sleeve in said housing in a direction of said longitudinal central axis of said insulating sleeve.

16. An implement according to claim 13, wherein said insulating sleeve is provided with a longitudinal rib for fixing a rotational position of said insulating sleeve in said housing.

17. An implement according to claim 7, wherein said insulating sleeve is provided with a shoulder for forming an abutment for said guide rod.

18. An implement according to claim 1, wherein said drive motor is an electric motor.
